(19) United States
(12) Patent Application Publication
(10) Pub. No.: US 2024/0430480 A1
(43) Pub. Date: Dec. 26, 2024

(54) METHOD AND APPARATUS FOR MESH AND POINT CLOUD CODING

(71) Applicants: HYUNDAI MOTOR COMPANY, SEOUL (KR); KIA CORPORATION, SEOUL (KR); DIGITALINSIGHTS INC., SEOUL (KR)

(72) Inventors: Jong Seok Lee, Seoul (KR); Yong Jo Ahn, Seoul (KR); Jin Heo, Yongin-si (KR); Seung Wook Park, Yongin-si (KR)

(73) Assignees: HYUNDAI MOTOR COMPANY, SEOUL (KR); KIA CORPORATION, SEOUL (KR)

(21) Appl. No.: 18/825,584

(22) Filed: Sep. 5, 2024

Related U.S. Application Data
(63) Continuation of application No. PCT/KR2023/002522, filed on Feb. 22, 2023.

(30) Foreign Application Priority Data
Mar. 22, 2022 (KR) 10-2022-0035266
Feb. 15, 2023 (KR) 10-2023-0020172

(51) Int. Cl. H04N 19/597; G06T 17/20; H04N 19/159

(52) U.S. Cl. CPC H04N 19/597; G06T 17/20; H04N 19/159

(57) ABSTRACT

A mesh and point cloud coding method and an apparatus predict with reference to a reconstructed point cloud in encoding/decoding a mesh to increase coding efficiency for three-dimensional meshes and point clouds. Alternatively, the mesh and point cloud coding method and the apparatus predict with reference to a reconstructed mesh in encoding/decoding a point cloud.

### CROSS REFERENCE TO RELATED APPLICATIONS

This application is a continuation of International Application No. PCT/KR2023/002522 filed on Feb. 22, 2023, which claims priority to and the benefit of Korean Patent Application No. 10-2022-0035266 filed on Mar. 22, 2022, and Korean Patent Application No. 10-2023-0020172, filed on Feb. 15, 2023, the entire contents of each of which are incorporated herein by reference.

### TECHNICAL FIELD

The present disclosure relates to a method and an apparatus for mesh and point cloud coding.

### BACKGROUND

The statements in this section merely provide background information related to the present disclosure and do not necessarily constitute prior art.

Conventional mesh compression techniques and point cloud compression techniques are used separately, and the mesh and point cloud are encoded/decoded by using separate compression techniques.

A mesh is a set of multiple faces in three-dimensional space. The mesh includes geometry information such as position coordinates of vertices in the three-dimensional space and connectivity information for polygons between the vertices, and the mesh may use the position coordinates and connectivity information of the vertices to represent a three-dimensional volume for a particular object in the three-dimensional space. The mesh may further include attribute information for the faces of the polygons that enclose the three-dimensional volume. The mesh can also include attribute information for each vertex. Alternatively, the mesh can include attribute information in the form of a texture map which is generated by projecting the faces of the polygons into two-dimensional space. If the mesh includes a texture map, the mesh may further include coordinates on the texture map for each vertex of the polygons. The mesh may be composed of vertex coordinates, connectivity information, and attribute information, or the mesh may be composed of vertex coordinates, connectivity information, texture map coordinates, and texture map. Here, the attribute information may represent a color representation, such as RGB, YCbCr, or the like, or may represent information such as the material of a surface, reflectivity, or the like.

A point cloud is a collection of points in three-dimensional space and can represent a volume of three-dimensional space. The point cloud may include coordinate values of locations in the three-dimensional space and attribute values of the relevant points. Here, the attribute values may represent a color representation, such as RGB, YCbCr, or the like, or may represent information such as the material of a surface, reflectivity, or the like.

The mesh and the point cloud are both manners of representing three-dimensional space, wherein a dense point cloud may contain richer information than the mesh, and a sparse mesh, which includes connectivity information, may contain richer information in different aspects than the point cloud. There is, therefore, a need for a method of utilizing these complementary characteristics of the mesh and the point cloud when meshes and point clouds are encoded/decoded.

### SUMMARY

The present disclosure seeks to provide a mesh and point cloud coding method and an apparatus that predict with reference to a reconstructed point cloud in encoding/decoding a mesh to increase coding efficiency for three-dimensional meshes and point clouds. Or the mesh and point cloud coding method and the apparatus predict with reference to a reconstructed mesh in encoding/decoding a point cloud.

At least one aspect of the present disclosure provides a method performed by a point cloud-and-mesh decoding device for decoding a point cloud and a mesh. The method includes separating a bitstream into a first bitstream, a second bitstream, a third bitstream, a fourth bitstream, and a fifth bitstream. The method also includes reconstructing patch information by decoding the first bitstream. The method also includes reconstructing a geometric image by decoding the second bitstream. The method also includes reconstructing an occupancy image by decoding the third bitstream. The method also includes reconstructing an attribute image or a mesh texture map by decoding the fourth bitstream. The method also includes reconstructing geometry information of the mesh by decoding the fifth bitstream. Here, the geometry information of the mesh contains vertices of the mesh, connectivity of the mesh, and vertices of the mesh texture map.

Another aspect of the present disclosure provides a method performed by a point cloud-and-mesh encoding device for encoding a point cloud and a mesh. The method includes obtaining the point cloud and the mesh. The method also includes generating a point cloud image from the point cloud. Here, the point cloud image includes patch information, a geometric image, an occupancy image, and an attribute image. The method also includes encoding the patch information, encoding the geometric image, encoding the occupancy image, encoding the attribute image or a mesh texture map, and encoding geometry information of the mesh. Here, the geometry information of the mesh contains vertices of the mesh, connectivity of the mesh, and vertices of the mesh texture map.

Yet another aspect of the present disclosure provides a computer-readable recording medium storing a bitstream generated by a point cloud-and-mesh encoding method. The point cloud-and-mesh encoding method includes obtaining a point cloud and a mesh. The point cloud-and-mesh encoding method also includes generating a point cloud image from the point cloud. Here, the point cloud image includes patch information, a geometric image, an occupancy image, and an attribute image. The point cloud-and-mesh encoding method also includes encoding the patch information, encoding the geometric image, encoding the occupancy image, encoding the attribute image or a mesh texture map, and encoding geometry information of the mesh. Here, the geometry information of the mesh contains vertices of the mesh, connectivity of the mesh, and vertices of the mesh texture map.

As described above, the present disclosure provides a mesh and point cloud coding method and an apparatus that predict with reference to a reconstructed point cloud in encoding/decoding a mesh. Or the mesh and point cloud coding method and the apparatus predict with reference to a reconstructed mesh in encoding/decoding a point cloud. Thus, the mesh and point cloud coding method and the apparatus increase coding efficiency for three-dimensional meshes and point clouds.

### BRIEF DESCRIPTION OF THE FIGURES

FIG. 1 is a block diagram of a point cloud-and-mesh encoding device, according to at least one embodiment of the present disclosure.

FIG. 2 is a diagram illustrating a reference structure referencing the form of a texture video, and a mesh texture map, according to at least one embodiment of the present disclosure.

FIG. 3 is a diagram illustrating a reference structure referencing the form of a texture video, and an attribute image of a point cloud, according to at least one embodiment of the present disclosure.

FIG. 4 is a block diagram of a point cloud-and-mesh decoding device, according to at least one embodiment of the present disclosure.

FIG. 5 is a block diagram of a point cloud-and-mesh encoding device, according to another embodiment of the present disclosure.

FIG. 6 is a detailed block diagram of a point cloud encoder, according to at least one embodiment of the present disclosure.

FIG. 7 is a detailed block diagram of a mesh encoder, according to at least one embodiment of the present disclosure.

FIG. 8 is a block diagram of a point cloud-and-mesh decoding device, according to another embodiment of the present disclosure.

FIG. 9 is a detailed block diagram of a point cloud decoder, according to at least one embodiment of the present disclosure.

FIG. 10 is a detailed block diagram of a mesh decoder, according to at least one embodiment of the present disclosure.

FIG. 11 is a diagram illustrating a method of predicting geometry information and attribute information of a point cloud by using a reconstructed mesh.

FIG. 12 is a diagram illustrating a method of predicting geometry information and attribute information of a point cloud by using a reconstructed mesh having a texture map.

FIG. 13 is a diagram illustrating a method of predicting a mesh texture map by using a reconstructed point cloud of a previous frame.

FIG. 14 is a flowchart of a method of encoding a point cloud and a mesh, according to at least one embodiment of the present disclosure.

FIG. 15 is a flowchart of a method of decoding a point cloud and a mesh, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

The present disclosure relates to a method and an apparatus for coding meshes and point clouds. More specifically, the present disclosure provides a mesh and point cloud coding method and a device for predicting with reference to a reconstructed point cloud when a mesh is encoded/decoded, or for predicting with reference to a reconstructed mesh when a point cloud is encoded/decoded.

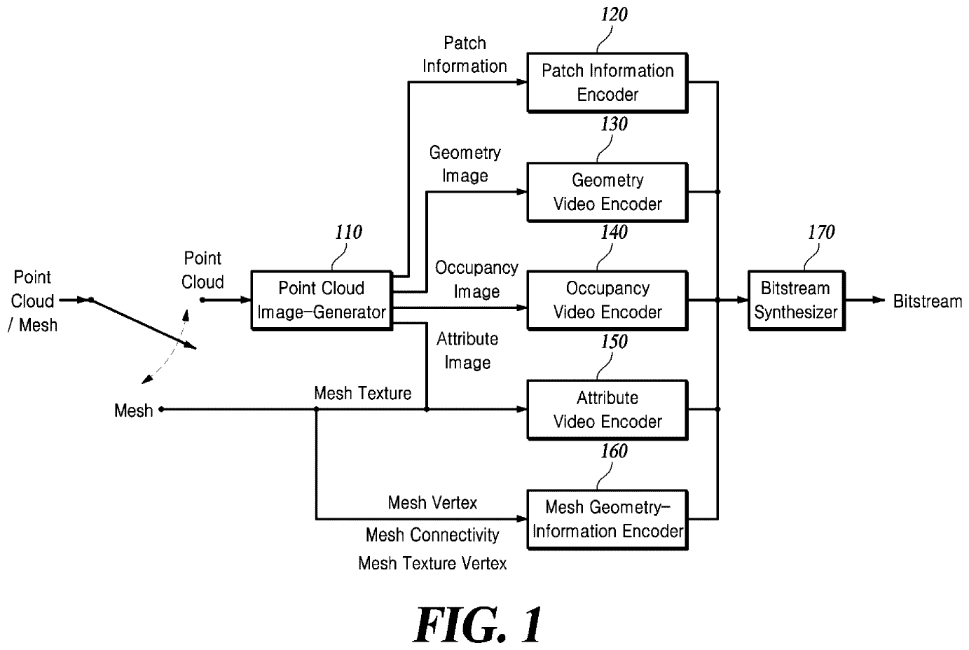

FIG. 1 is a block diagram of a point cloud-and-mesh encoding device, according to at least one embodiment of the present disclosure.

A point cloud-and-mesh encoding device (hereinafter used interchangeably with ‘encoding device’) encodes an inputted three-dimensional point cloud or mesh received as an input to generate a bitstream. Alternatively, the encoding device encodes an inputted three-dimensional point cloud and a mesh received as inputs to generate a bitstream. The encoding device may include all or part of a point cloud image-generator 110, a patch information encoder 120, a geometry video encoder 130, an occupancy video encoder 140, an attribute video encoder 150, a mesh geometry-information encoder 160, and a bitstream synthesizer 170.

The input of the encoding device may include both a three-dimensional point cloud and a mesh. Further, the output of the encoding device may include both a bitstream for the three-dimensional point cloud and a bitstream for the three-dimensional mesh.

The point cloud image-generator 110 receives the point cloud as input and generates patch information, a geometric image, an occupancy image, and an attribute image. Here, the patch information, the geometric image, and the occupancy image may all be generated from the geometry information of the point cloud.

The patch information is used by the point cloud image-generator 110 when mapping or projecting a plurality of patches categorized in a three-dimensional space onto a two-dimensional projective plane. Thus, the patch information may include a coordinate value in the three-dimensional space of each patch and information in the three-dimensional space such as width, length, depth, and the like. It may also include information such as coordinate values in a two-dimensional projective plane and information such as horizontal and vertical lengths.

The geometric image is an image obtained by using the generated patch information and after two-dimensionally mapping the distances between the points' locations in the three-dimensional space and the projective plane. In other words, the geometric image may be a map of the depth between the points and the two-dimensional plane when the three-dimensional space is projected onto the two-dimensional plane. In this case, the two-dimensional plane may be one of an x-y plane, a y-z plane, and an x-z plane.

On the other hand, if the three-dimensional patch has a volume in three-dimensional space, multiple three-dimensional points may be projected to a single two-dimensional location. In such cases, there may be multiple depths, which may then generate multiple geometric images. Typically, two geometric images may be generated in total, one for the nearest three-dimensional point and one for the farthest three-dimensional point.

The occupancy image is an image indicative of the positions where the multiple patches classified in the three-dimensional space are projected by the point cloud image-generator 110 as an image on the two-dimensional projective plane. The occupancy image may be a binary map that expresses by 0 or 1 whether a point is projected or not for the position of each pixel. The generated patch information, the generated geometric image, and the generated occupancy image may be transferred to the patch information encoder 120, the geometry video encoder 130, and the occupancy video encoder 140, respectively.

Meanwhile, the attribute image may be generated from the attribute information of the point cloud. The attribute image is a two-dimensional image generated by projecting the attribute values of the points in the three-dimensional space onto a projective plane. The generated attribute image may be transferred to the attribute video encoder 150.

The patch information encoder 120 may encode the patch information to generate a bitstream. At this time, the regular entropy-encoded bitstream may be transferred to the bitstream synthesizer 170.

The geometry video encoder 130 encodes one or more geometric images to generate a bitstream. At this time, the geometry video encoder 130 may use a video encoding technology such as H.264/AVC (Advanced Video Coding), HEVC (High Efficiency Video Coding), VVC (Versatile Video Coding), VP8, VP9, AV1, or the like. The generated bitstream may be transferred to the bitstream synthesizer 170.

The occupancy video encoder 140 encodes the occupancy image to generate the bitstream. At this time, the occupancy video encoder 140 may use a video encoding technology such as H.264/AVC, H.265/HEVC, H.266/VVC, VP8, VP9, AV1, or the like. The generated bitstream may be transferred to the bitstream synthesizer 170.

The attribute video encoder 150 receives and then encodes an attribute image or mesh texture map to generate a bitstream. At this time, the attribute video encoder 150 may use a video encoding technology such as H.264/AVC, H.265/HEVC, H.266/VVC, VP8, VP9, AV1, or the like. The generated bitstream may be transferred to the bitstream synthesizer 170. The encoding device may determine, on a frame-by-frame basis, information indicating whether the image to be encoded is an attribute image of a point cloud or a mesh's texture map, and may transfer the information to the decoding device.

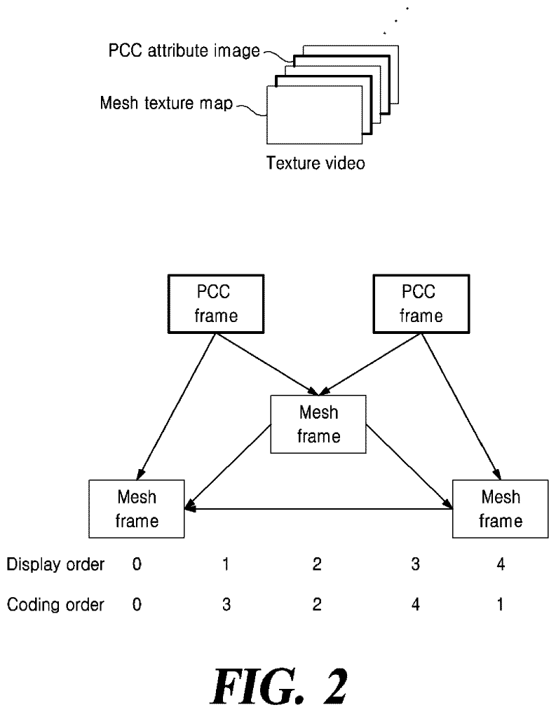

Meanwhile, the attribute image and the mesh texture map may be inputted to the attribute video encoder 150 in the order as shown in the top example of FIG. 2. Further, the attribute video encoder 150 may perform video encoding by using a reference structure such as the bottom example of FIG. 2. For example, the attribute video encoder 150 for encoding the attribute image of the point cloud, may perform inter prediction by referring to the mesh texture map, thereby encoding the attribute image efficiently. In the example of FIG. 2, PCC indicates Point Cloud Coding.

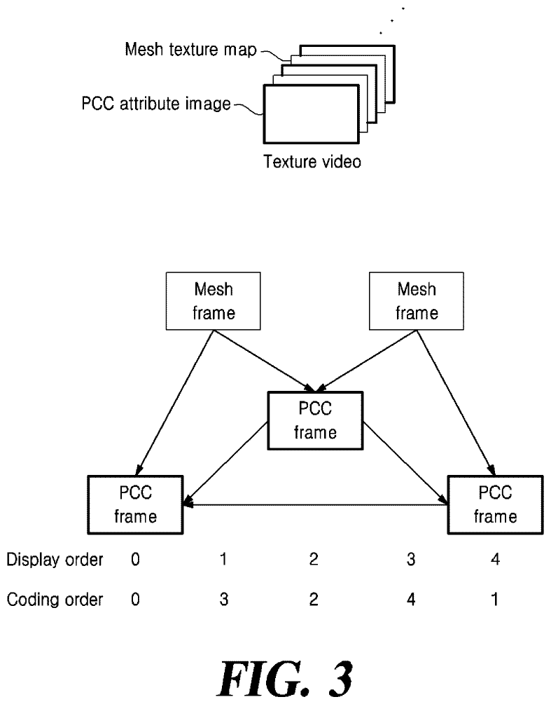

As another example, the attribute image and mesh texture map may be inputted to the attribute video encoder 150 in the order as in the top example of FIG. 3. Furthermore, the attribute video encoder 150 may perform video encoding by using a reference structure such as the bottom example of FIG. 3. For example, the attribute video encoder 150 for encoding the mesh texture map, may perform inter prediction by referring to the attribute image of the point cloud, thereby encoding the mesh texture map efficiently.

The mesh geometry-information encoder 160 encodes the mesh vertices, connectivity, texture map vertices, and the like to generate a bitstream. In this case, the mesh vertices, connectivity, and texture map vertices may be generated by a mesh geometry information-compression technique such as TFAN (Triangle-FAN) or DRACO, which are mesh compression methods. The generated bitstream may be transferred to the bitstream synthesizer 170.

Hereinafter, mesh vertices may implicitly represent the vertex coordinates of the mesh. Further, texture map vertices may implicitly represent texture map vertex coordinates.

The bitstream synthesizer 170 concatenates all of the received bitstreams to generate a single bitstream. The order of each bitstream may be determined by an arrangement between the encoding device and the decoding device. Alternatively, the bitstreams may be concatenated in any order. Alternatively, each bitstream may include a symbol at the beginning of the bitstream that represents the type of bitstream. In this case, the bitstream synthesizer 170 may determine the type of each bitstream and may concatenate the bitstreams in a preset order. Alternatively, the encoding device may concatenate the bitstreams in any order, and the decoding device may decode their symbols and may separate the bitstreams according to those symbols.

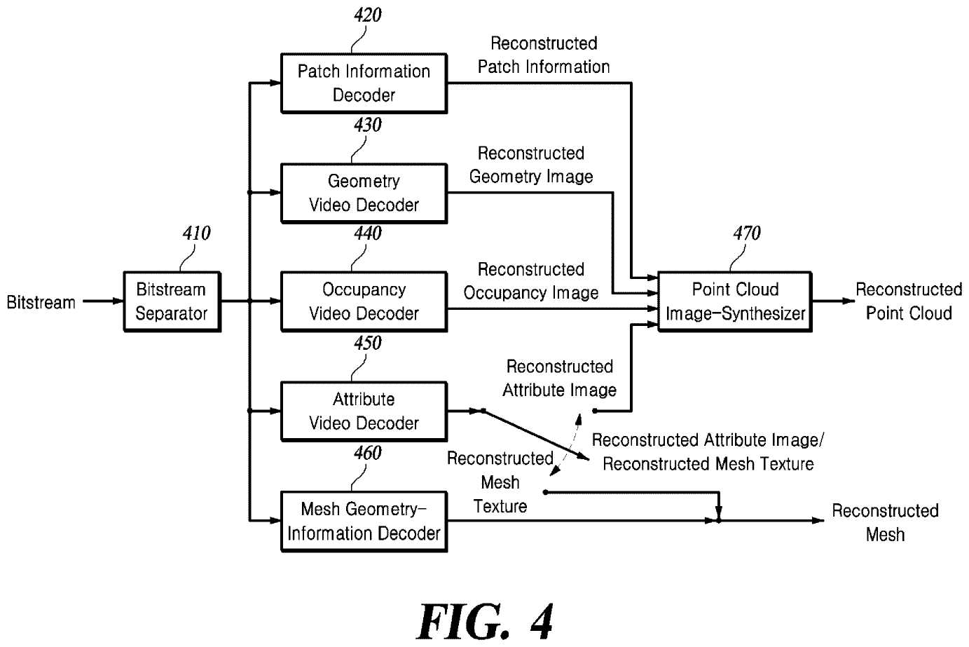

FIG. 4 is a block diagram of a point cloud-and-mesh decoding device, according to at least one embodiment of the present disclosure.

The point cloud-and-mesh decoding device (hereinafter used interchangeably with “decoding device”) reconstructs a three-dimensional point cloud and mesh from the bitstream. Alternatively, the decoding device may reconstruct a three-dimensional point cloud or mesh from the bitstream. The decoding device may include all or part of a bitstream separator 410, a patch information decoder 420, a geometry video decoder 430, an occupancy video decoder 440, an attribute video decoder 450, a mesh geometry-information decoder 460, and a point cloud image-synthesizer 470.

The input to the decoding device may contain both a bitstream for a three-dimensional point cloud and a bitstream for a three-dimensional mesh. The output of the decoding device may contain both the three-dimensional point cloud and the mesh.

The bitstream separator 410 receives and then separates the bitstream into multiple bitstreams. The separated bitstreams may be delivered to the patch information decoder 420, the geometry video decoder 430, the occupancy video decoder 440, the attribute video decoder 450, and the mesh geometry-information decoder 460.

The patch information decoder 420 decodes the inputted bitstream to reconstruct the patch information. The reconstructed patch information may be delivered to the point cloud image-synthesizer 470.

The geometry video decoder 430 decodes the received bitstream to reconstruct a geometric image. At this time, the geometry video decoder 430 may use a video decoding technique. The reconstructed geometric image may be transferred to the point cloud image-synthesizer 470.

The occupancy video decoder 440 decodes the inputted bitstream to reconstruct the occupancy image. At this time, the occupancy video decoder 440 may use a video decoding technique. The reconstructed occupancy image may be transferred to the point cloud image-synthesizer 470.

The attribute video decoder 450 may decode the inputted bitstream to reconstruct an attribute image or a mesh texture map. At this time, the attribute video decoder 450 may use a video decoding technique. Meanwhile, the decoding device may receive, from the encoding device on a frame-by-frame basis, information indicating whether the image to be reconstructed is an attribute image of a point cloud or a mesh texture map. If the information indicates an attribute image of the point cloud, the reconstructed image may be transferred to the point cloud image-synthesizer 470. If the information indicates a mesh texture map, the reconstructed image may be combined with the results generated by the mesh geometry-information decoder 460 to generate a reconstructed mesh.

Meanwhile, the attribute video decoder 450 may perform inter prediction as illustrated in FIG. 2 or FIG. 3. As in the example of FIG. 2, the attribute video decoder 450 may perform inter prediction by referring to the mesh texture map for decoding the attribute image of the point cloud. Alternatively, as in the example of FIG. 3, the attribute video decoder 450 may perform inter prediction by referring to the attribute image of the point cloud for decoding the mesh texture map.

The mesh geometry-information decoder 460 may receive a bitstream as input to reconstruct the geometry information of the mesh. In this case, the geometry information of the mesh may include mesh vertices, mesh connectivity, and information on the texture vertices of the mesh. The reconstructed geometry information may be combined with the reconstructed mesh texture map generated by the attribute video decoder 450 and the form of a reconstructed mesh may be outputted by combination.

The point cloud image-synthesizer 470 combines the reconstructed patch information, the geometric image, the occupancy image, and the attribute image to reconstruct a point cloud.

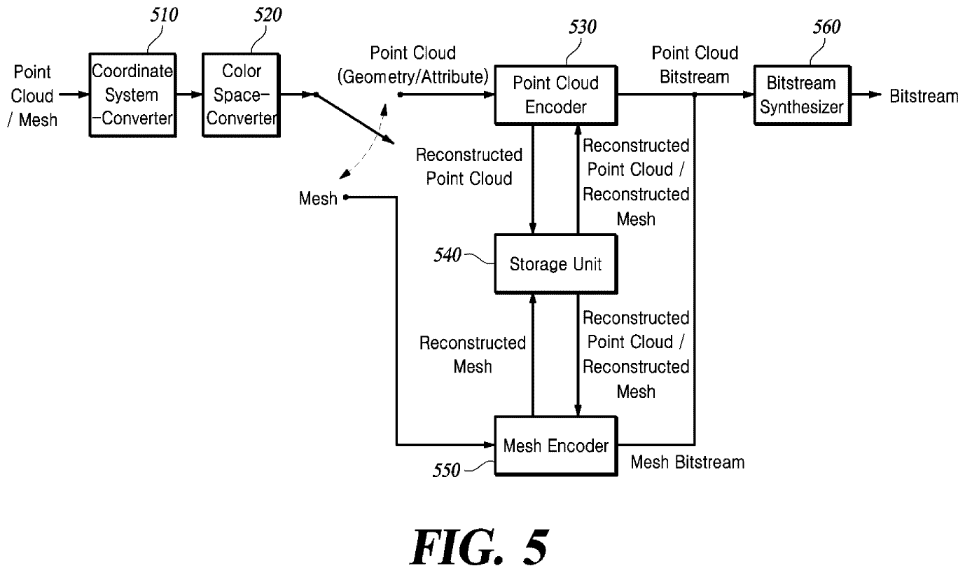

Referring now to FIGS. 5 through 7, a point cloud-and-mesh encoding device utilizing a reconstructed point cloud or a reconstructed mesh is described.

FIG. 5 is a block diagram of a point cloud-and-mesh encoding device, according to another embodiment of the present disclosure.

The encoding device encodes a point cloud and a mesh inputted to generate a bitstream. Alternatively, the encoding device may encode an inputted point cloud or mesh to generate a bitstream. The encoding device may include all or part of a coordinate system-converter 510, a color space-converter 520, a point cloud encoder 530, a storage unit 540, a mesh encoder 550, and a bitstream synthesizer 560.

The coordinate system-converter 510 receives the point cloud and mesh as input and converts their coordinate systems to generate the converted point cloud and/or mesh. At this time, a coordinate system conversion may be used for converting a Cartesian coordinate system to a cylindrical coordinate system. Alternatively, a coordinate system conversion may be used for converting a spherical coordinate system to a cylindrical coordinate system. Alternatively, a coordinate system conversion may be used for converting a cylindrical coordinate system to a spherical coordinate system. In other words, interconversions between the Cartesian, cylindrical, and spherical coordinate systems are feasible, and information about the determined conversion may be communicated to the decoding device. The decoding device may perform a coordinate system inversion based on that information.

On the other hand, if the three-dimensional coordinates of the point cloud and the mesh are in a world standard coordinate system, the coordinate system conversion may include converting the world standard coordinate system to the internal coordinate system of the encoding device. Here, if the input to the coordinate system-converter 510 is a point cloud, the coordinate system-converter 510 may convert the coordinate system for coordinate values that are geometry information of each point. Alternatively, if the input is a mesh, the coordinate system-converter 510 may convert the coordinate system for the three-dimensional coordinate values of the mesh vertices.

The color space-converter 520 receives input of a point cloud and/or a mesh and performs a color space conversion on the point cloud and/or the mesh to generate a converted point cloud and/or the mesh. At this time, if the input to the color space-converter 520 is a point cloud, the color space-converter 520 may convert the color space for the attribute information of each point. At this time, by using the information received from the higher level, the encoding device may determine the number of channels and types of the attribute information. For example, the attribute information may have three color channels, such as RGB, YUV, YCbCr, and the like. Alternatively, the attribute information may contain a reflection coefficient, such as reflectance alone. Alternatively, the attribute information may include four channels, such as RGB+reflectance. Accordingly, the color space-converter 520 may convert the color space for the remaining color channels except for reflectance. If the attribute information includes reflectance alone, the color space conversion may be omitted. The encoding device may transfer the information items used for the color space conversion to the decoding device. The decoding device may perform the inverse process of the color space conversion based on the information.

The point cloud encoder 530 receives input of a point cloud, a reconstructed point cloud, and/or a reconstructed mesh, and encodes the point cloud to generate a point cloud bitstream and a reconstructed point cloud. The reconstructed point cloud may be delivered to the storage unit 540, and the point cloud bitstream may be delivered to the bitstream synthesizer 560.

The mesh encoder 550 receives input of the mesh, the reconstructed mesh, and/or the reconstructed point cloud, and encodes the mesh to generate a mesh bitstream and a reconstructed mesh. The reconstructed mesh may be transferred to the storage unit 540, and the mesh bitstream may be transferred to the bitstream synthesizer 560.

The storage unit 540 receives and stores the reconstructed point cloud or reconstructed mesh when inputted. The reconstructed point cloud and the reconstructed mesh may then be used for point cloud or mesh encoding/decoding.

The bitstream synthesizer 560 concatenates all the inputted bitstreams to generate a single bitstream.

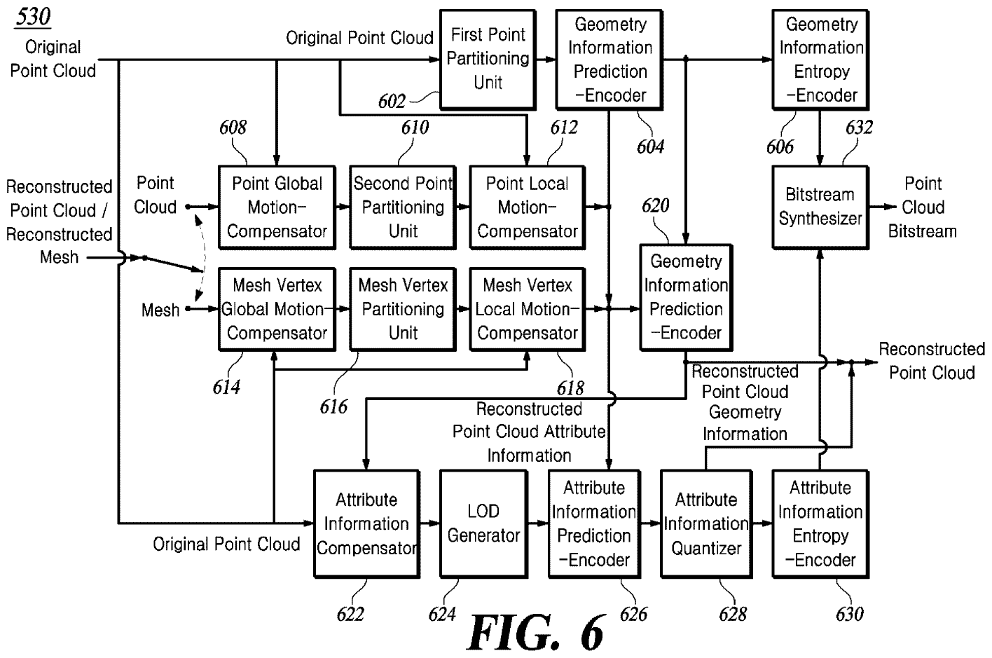

FIG. 6 is a detailed block diagram of a point cloud encoder, according to at least one embodiment of the present disclosure.

As described above, upon receiving input of an original point cloud, a reconstructed point cloud, and/or a reconstructed mesh, the point cloud encoder 530 may encode the original point cloud to generate a point cloud bitstream and may generate a reconstructed point cloud. The point cloud encoder 530 may include all or some of the following: a first point partitioning unit 602, a geometry information prediction-encoder 604, a geometry information entropy-encoder 606, a point global motion-compensator 608, a second point partitioning unit 610, a point local motion-compensator 612, a mesh vertex global motion-compensator 614, and a mesh vertex partitioning unit 616, mesh vertex local motion-compensator 618, geometry information prediction-decoder 620, attribute information compensator 622, level-of-detail (LOD) generator 624, attribute information prediction-encoder 626, attribute information quantizer 628, attribute information entropy-encoder 630, and bitstream synthesizer 632.

The first point partitioning unit 602 utilizes the geometry information of the inputted original point cloud to partition points in three-dimensional space according to a tree structure-based partitioning method, such as a binary tree, a quadtree, an octree, a K-dimension tree, or the like. The partitioned points of the point cloud may be transferred to the geometry information prediction-encoder 604.

The point global motion-compensator 608 receives the reconstructed point cloud and the original point cloud as input and performs global motion compensation on the geometry information of the reconstructed point cloud. The global motion compensation may be performed by using a parameter representing the global motion between the original point cloud and the reconstructed point cloud. In this case, the global motion compensation uses the same parameters for all points to compensate for the motion. The global motion parameters may be generated by a least squares method by using the geometry information of the original point cloud and the reconstructed point cloud. At this time, the generated parameters may be entropy-encoded and transferred to the decoding device. The global motion-compensated reconstructed point cloud may be transferred to the second point partitioning unit 610.

The second point partitioning unit 610 receives the global motion-compensated reconstructed point cloud and partitions the global motion-compensated reconstructed point cloud into smaller units. At this time, used as the partitioning method may be a tree structure-based partitioning method such as a binary tree, quadtree, octree, K-D tree, or the like. The partitioned point cloud may be transferred to the point local motion-compensator 612.

The point local motion-compensator 612 uses the geometry information of the inputted partitioned point cloud and the geometry information of the original point cloud to perform local motion compensation on the partitioned point cloud. The point local motion-compensator 612 may calculate a local motion compensation parameter by using the original point cloud and the reconstructed point cloud, and then may use the local motion compensation parameter to perform local motion compensation. A difference may be determined between the currently partitioned point cloud unit and the point cloud unit with the smallest error in the original point cloud, and the difference may be represented by a three-dimensional vector that is assigned to the motion compensation parameter. The generated parameter may be entropy-encoded and then may be transferred to the decoding device. The motion-compensated point cloud may be transferred to the geometry information prediction-encoder 604 and the attribute information prediction-encoder 626.

The mesh vertex global motion-compensator 614 receives the reconstructed mesh and the original point cloud as input and performs global motion compensation on the mesh vertices. The global motion-compensated mesh may be transferred to the mesh vertex partitioning unit 616. The parameters used for motion compensation may be entropy-encoded and may be transferred to the decoding device.

The mesh vertex partitioning unit 616 partitions the mesh vertices into smaller units. In this case, a tree structure-based partitioning method such as a binary tree, quadtree, octrec, K-D tree, or the like may be used as the partitioning method. The partitioned mesh vertices may be transferred to the mesh vertex local motion-compensator 618.

The mesh vertex local motion-compensator 618 performs motion compensation on the partitioned mesh vertices respectively by using the partitioned mesh vertices and the original point cloud. The mesh vertex local motion-compensator 618 may perform the motion compensation by calculating the parameters required for the motion compensation by using the current point cloud and the reconstructed mesh vertices. Here, the parameter required for motion compensation is a motion vector, which may be a three-dimensional vector. Alternatively, the mesh local motion-compensator 618 may perform a coordinate conversion for each vertex by using a matrix with 6 or 9 elements, such as an affine transform, as parameters. The parameters used for motion compensation may be entropy-encoded and may be transferred to the decoding device. The motion-compensated mesh may be transferred to the geometry information prediction-encoder 604 and the attribute information prediction-encoder 626.

The geometry information prediction-encoder 604 receives the partitioned current point cloud and the motion-compensated reconstructed point cloud, or the partitioned current point cloud and the motion-compensated reconstructed mesh, and performs a prediction encode on the geometry information of the current point cloud. The symbols associated with the geometry information generated by the prediction encoding may be transferred to the geometry information entropy-encoder 606 and the geometry information predictive decoding unit 620.

The geometry information entropy-encoder 606 entropy-encodes the inputted geometry information symbols to generate a bitstream. The generated bitstream may be transferred to the bitstream synthesizer 632.

The geometry information prediction-decoder 620 reconstructs the current point cloud by using the inputted geometry information symbols. The reconstructed point cloud is transferred to the attribute information compensator 622 and may be used for the next point cloud or mesh encoding.

The attribute information compensator 622 receives the attribute information of the current point cloud and the geometry information of the reconstructed current point cloud to correct the attribute information of the current point cloud. The attribute information compensation may use the attribute values of the closest original point cloud based on the reconstructed geometry information. Alternatively, the attribute information of the current point may be determined based on the attribute information of the three closest points based on the reconstructed geometry information. In this case, the weights for the three points may be determined based on distance. The attribute-corrected point cloud may be transferred to the LOD generator 624.

The LOD generator 624 receives the attribute-corrected point cloud and divides the attribute-corrected point cloud into a plurality of levels to form a level of detail (LOD). As the LOD level increases, all points are included, and a lower LOD may include only a small number of points, such as only enough to maintain the shape of a three-dimensional object. Here, the points included in each LOD level may be categorized based on distance. The point cloud partitioned into multiple levels may be transferred to the attribute information prediction-encoder 626.

The attribute information prediction-encoder 626 receives the LOD partitioned point cloud, the motion-compensated reconstructed point cloud, and/or the motion-compensated reconstructed mesh as input and performs prediction encoding for each point. The residual attribute information generated by the prediction encoding may be transferred to the attribute information quantizer 628. In addition, the prediction information of the points may be transferred to the attribute information quantizer 628.

The attribute information quantizer 628 receives the residual attribute information and performs quantization to generate attribute information symbols. The generated attribute information symbols may be transferred to the attribute information entropy-encoder 630. Furthermore, the attribute information quantizer 628 may dequantize the symbols according to the quantization and may reconstruct the attribute information of the point cloud by using the received prediction information. The reconstructed point cloud attribute information may be used for encoding the next frame.

The attribute information entropy-encoder 630 entropy-encodes the inputted attribute information symbols to generate a bitstream. The generated bitstream may be transferred to the bitstream synthesizer 632.

The bitstream synthesizer 632 concatenates all of the received bitstreams to generate a point cloud bitstream.

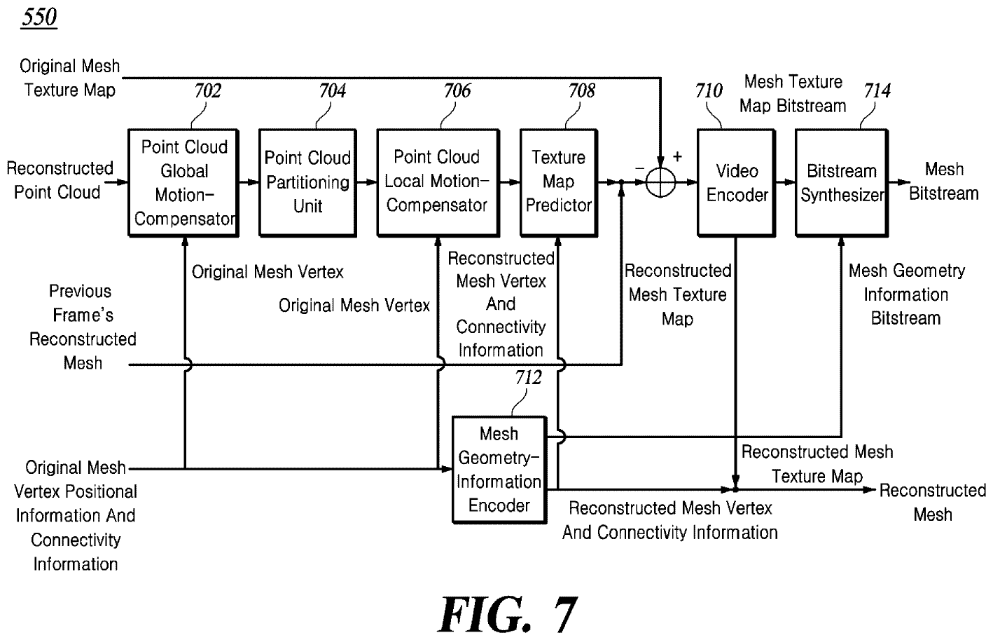

FIG. 7 is a detailed block diagram of a mesh encoder, according to at least one embodiment of the present disclosure.

As described above, the mesh encoder 550 receives input of an original mesh, a reconstructed point cloud, and/or an original mesh and a reconstructed mesh of a previous frame, encodes the original mesh to generate a mesh bitstream, and generates a reconstructed mesh of the current frame. The mesh encoder 550 may include all or part of a point cloud global motion-compensator 702, a point cloud partitioning unit 704, a point cloud local motion-compensator 706, a texture map predictor 708, a video encoder 710, a mesh geometry-information encoder 712, and a bitstream synthesizer 714.

The point cloud global motion-compensator 702 receives the reconstructed point cloud and the original mesh vertices as input to perform global motion compensation. The global motion compensation may be performed by using a parameter representing the global motion between the original mesh and the reconstructed point cloud. In this case, the global motion compensation uses the same parameter for all points to perform the motion compensation. The global motion parameters may be generated by a least squares method by using the geometry information of the original mesh and the reconstructed point cloud. The generated parameters may be entropy-encoded and then may be transferred to the decoding device. The global motion-compensated reconstructed point cloud may be transferred to the point cloud partitioning unit 704.

The point cloud partitioning unit 704 receives and partitions the global motion-compensated reconstructed point cloud into smaller units. In this case, a tree structure-based partitioning method such as a binary tree, quadtree, octree, K-D tree, or the like may be used as the partitioning method. The partitioned point cloud may be transferred to the point cloud local motion-compensator 706.

The point cloud local motion-compensator 706 receives the partitioned point cloud and the original mesh vertices as input and performs local motion compensation on the partitioned point cloud. At this time, the information used for motion compensation may be entropy-encoded and then may be transferred to the decoding device. The local motion-compensated point cloud may be transferred to the texture map predictor 708.

The mesh geometry-information encoder 712 receives the inputted position information of the original mesh vertices and the connectivity information of the vertices, encodes the inputted information to generate a mesh geometry information bitstream, and the reconstructed mesh vertices and connectivity information. The generated mesh geometry information bitstream may be transferred to the bitstream synthesizer 714, and the reconstructed mesh vertex and connectivity information may be outputted along with the reconstructed mesh texture map, which may be used for the next point cloud or mesh encoding. The reconstructed mesh vertices and connectivity information may also be transferred to the texture map predictor 708.

The texture map predictor 708 utilizes the motion-compensated point cloud, and the reconstructed mesh vertices and connectivity information to generate a predicted texture map. The texture map predictor 708 may subtract the predicted texture map from the original texture map to generate a differential texture map, which may then be transferred to the video encoder 710. Here, if a reconstructed point cloud is not inputted to the mesh encoder 550, but a reconstructed mesh of a previous frame is inputted, the differential texture map obtained by subtracting the texture map of the reconstructed mesh of the previous frame from the original mesh texture map may be transferred to the video encoder 710.

The video encoder 710 encodes the inputted differential texture map to generate a mesh texture map bitstream. The video encoder 710 may use an image compression technique such as Portable Network Graphics (PNG), Joint Photographic coding Experts Group (JPEG), JPEG2000, High Efficiency Image File Format (HEIF), or the like. Alternatively, the video encoder 710 may use video encoding technologies such as MPEG-2, H.264/AVC, H.265/HEVC, H.266/VVC, VP8, VP9, AV1, or the like. The mesh texture map bitstream may be transferred to the bitstream synthesizer 714.

The bitstream synthesizer 714 concatenates all of the inputted bitstreams to generate a mesh bitstream.

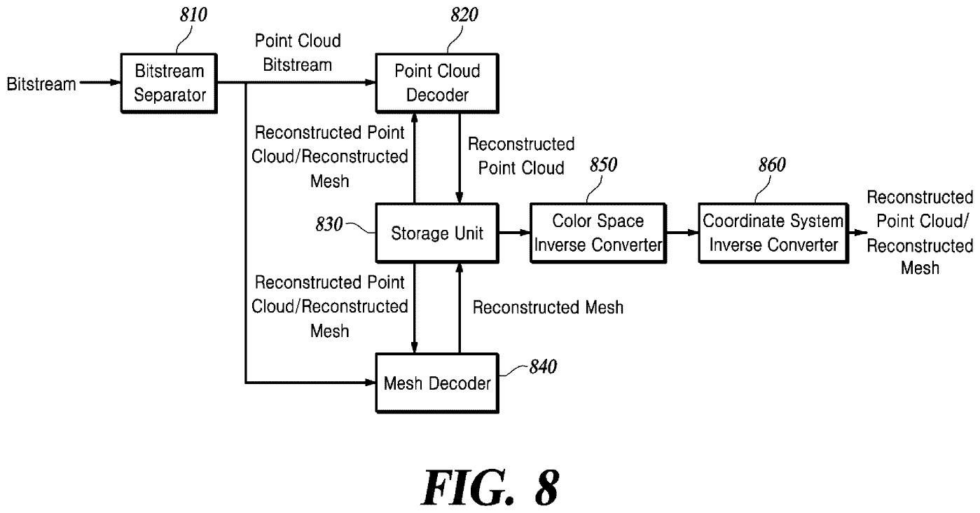

Referring now to FIGS. 8 through 10, the following describes a point cloud-and-mesh decoding device utilizing a reconstructed point cloud or a reconstructed mesh.

FIG. 8 is a block diagram of a point cloud-and-mesh decoding device, according to another embodiment of the present disclosure.

The decoding device receives a bitstream as input to generate a reconstructed point cloud and/or a reconstructed mesh. The decoding device may include all or part of a bitstream separator 810, a point cloud decoder 820, a storage unit 830, a mesh decoder 840, a color space inverse converter 850, and a coordinate system inverse converter 860.

The bitstream separator 810 separates the inputted bitstream into a point cloud bitstream and a mesh bitstream. The separated point cloud bitstream may be transferred to the point cloud decoder 820. The separated mesh bitstream may be transferred to the mesh decoder 840.

The point cloud decoder 820 receives the point cloud bitstream, the reconstructed point cloud of the previous frame, and/or the reconstructed mesh to reconstruct the point cloud of the current frame. The reconstructed point cloud of the current frame may be transferred to the storage unit 830.

The mesh decoder 840 may reconstruct the mesh of the current frame by receiving the mesh bitstream, the reconstructed point cloud, and/or the reconstructed mesh. The reconstructed mesh of the current frame may be transferred to the storage unit 830.

The storage unit 830 may store the reconstructed point cloud and the reconstructed mesh of the current frame and may transfer the reconstructed point cloud and mesh to the point cloud decoder 820 and the mesh decoder 840 for decoding subsequent frames. Further, the storage unit 830 may transfer the reconstructed point cloud and mesh to the color space inverse converter 850.

The color space inverse converter 850 may receive the reconstructed point cloud and mesh, may perform a color space inversion on the attribute information of the point cloud and the mesh texture map, and may transfer the inverted attribute information and mesh texture map to the coordinate system inverse converter 860.

The coordinate system inverse converter 860 receives the color space-converted point cloud and the mesh and applies the coordinate system inversion to the geometry information of the point cloud and the mesh vertices to generate a reconstructed point cloud and a reconstructed mesh.

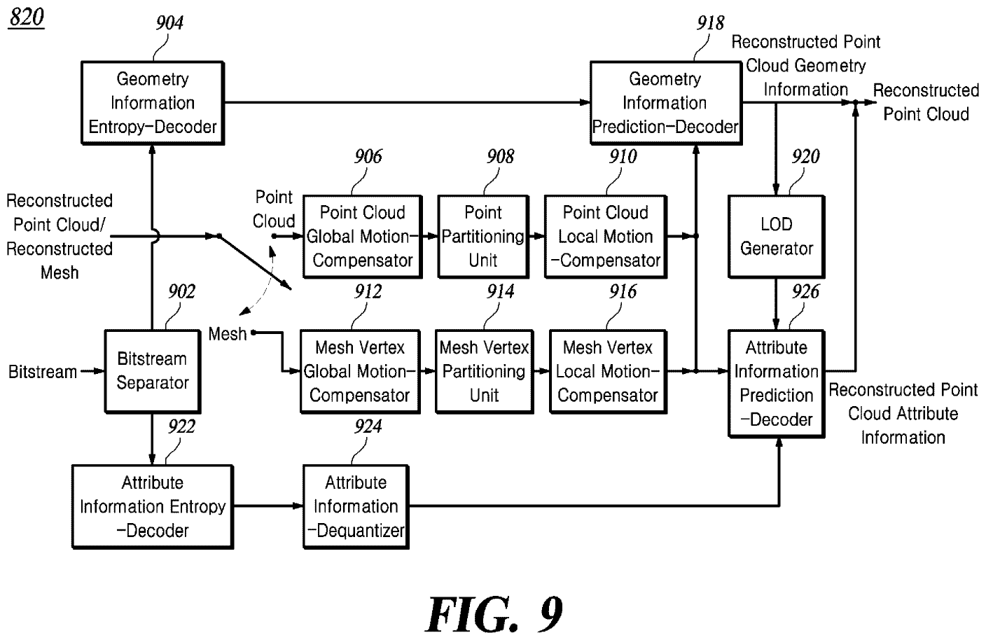

FIG. 9 is a detailed block diagram of a point cloud decoder, according to at least one embodiment of the present disclosure.

The point cloud decoder 820 generates a reconstructed point cloud by inputting a bitstream, a reconstructed point cloud of a previous frame, and a reconstructed mesh. The point cloud decoder 820 may include all or some of the following: a bitstream separator 902, a geometry information entropy-decoder 904, a point cloud global motion-compensator 906, a point partitioning unit 908, a point cloud local motion-compensator 910, a mesh vertex global motion-compensator 912, and a mesh vertex partitioning unit 914, a mesh vertex local motion-compensator 916, a geometry information prediction-decoder 918, a LOD generator 20, an attribute information entropy-decoder 922, an attribute information-dequantizer 924, and an attribute information prediction-decoder 926.

The bitstream separator 902 receives the bitstream and separates the bitstream into a point cloud geometry information bitstream and a point cloud attribute information bitstream. The point cloud geometry information bitstream may be transferred to the geometry information entropy-decoder 904, and the point cloud attribute information bitstream may be transferred to the attribute information entropy-decoder 922.

The geometry information entropy-decoder 904 decodes the point cloud geometry information bitstream to generate geometry information symbols and parameters required for motion compensation. The generated geometry information symbols may be transferred to the geometry information prediction-decoder 918.

The point cloud global motion-compensator 906 receives the reconstructed point cloud input and performs global motion compensation on the geometry information of the reconstructed point cloud. The global motion compensation may be performed by using a parameter representing the global motion between the original point cloud and the reconstructed point cloud. In this case, the global motion compensation uses the same parameters for all points to perform the motion compensation. The global motion parameters may be obtained from the geometry information entropy-decoder 904. The global motion-compensated reconstructed point cloud may be transferred to the point partitioning unit 908.

The point partitioning unit 908 receives and partitions the global motion-compensated reconstructed point cloud into smaller units. In this case, a tree structure-based partitioning method such as a binary tree, quadtree, octree, K-D tree, or the like may be used as the partitioning method. The partitioned point cloud may be transferred to the point local motion-compensator 910.

The point cloud local motion-compensator 910 performs local motion compensation on the geometry information of the inputted partitioned point clouds by using parameters related to local motion compensation. Here, the parameters may be motion vectors represented as three-dimensional vectors. Further, the parameters may be obtained from the geometry information entropy-decoder 904. The motion-compensated point cloud may be transferred to the geometry information prediction-decoder 918 and the attribute information prediction-decoder 926.

The mesh vertex global motion-compensator 912 receives the reconstructed mesh as input and performs global motion compensation on the mesh vertices. At this time, the global motion parameters for the global motion compensation may be obtained from the geometry information entropy-decoder 904. The global motion-compensated mesh may be transferred to the mesh vertex partitioning unit 914.

The mesh vertex partitioning unit 914 partitions the mesh vertices into smaller units. In this case, a tree structure-based partitioning method such as a binary tree, quadtree, octree, K-D tree, or the like may be used as the partitioning method. The partitioned mesh vertices may be transferred to the mesh vertex local motion-compensator 916.

The mesh vertex local motion-compensator 916 performs motion compensation on each of the partitioned mesh vertices. At this time, the motion compensation may utilize the parameters related to local motion compensation transmitted from the encoding device. Here, the parameter required for motion compensation may be a motion vector. The motion vector may mean a three-dimensional vector. Alternatively, the mesh vertex local motion-compensator 916 may perform a coordinate conversion for each vertex by utilizing a matrix having 6 or 9 elements, such as an affine transform, as a parameter. Parameters related to motion compensation may be obtained from the geometry information entropy-decoder 904. The motion compensated mesh may be transferred to the geometry information prediction-decoder 918 and the attribute information prediction-decoder 926.

The geometry information prediction-decoder 918 receives the geometry information symbols, the motion-compensated point cloud of the previous frame, and the motion-compensated mesh of the previous frame to reconstruct the geometry information of the point cloud of the current frame. The reconstructed point cloud geometry information may be outputted along with the reconstructed point cloud attribute information. Further, the reconstructed point cloud geometry information may be transferred to the LOD generator 920.

The LOD generator 920 partitions the point cloud by constructing a plurality of LODs by using the inputted point cloud geometry information. The point cloud partitioned according to the LODs may be transferred to the attribute information prediction-decoder 926.

The attribute information entropy-decoder 922 decodes the inputted point cloud attribute information bitstream to reconstruct the quantized residual attribute information of the point cloud. The quantized residual attribute information may be transferred to the attribute information-dequantizer 924.

The attribute information-dequantizer 924 dequantizes the inputted quantized residual attribute information to reconstruct the residual attribute information. The reconstructed residual attribute information may be transferred to the attribute information prediction-decoder 926.

The attribute information prediction-decoder 926 reconstructs the attribute information of the current frame by using the inputted reconstructed residual attribute information, the LOD partitioned point cloud, the motion-compensated point cloud of the previous frame, and/or the motion-compensated mesh of the previous frame. The reconstructed point cloud attribute information may be outputted along with the reconstructed point cloud geometry information.

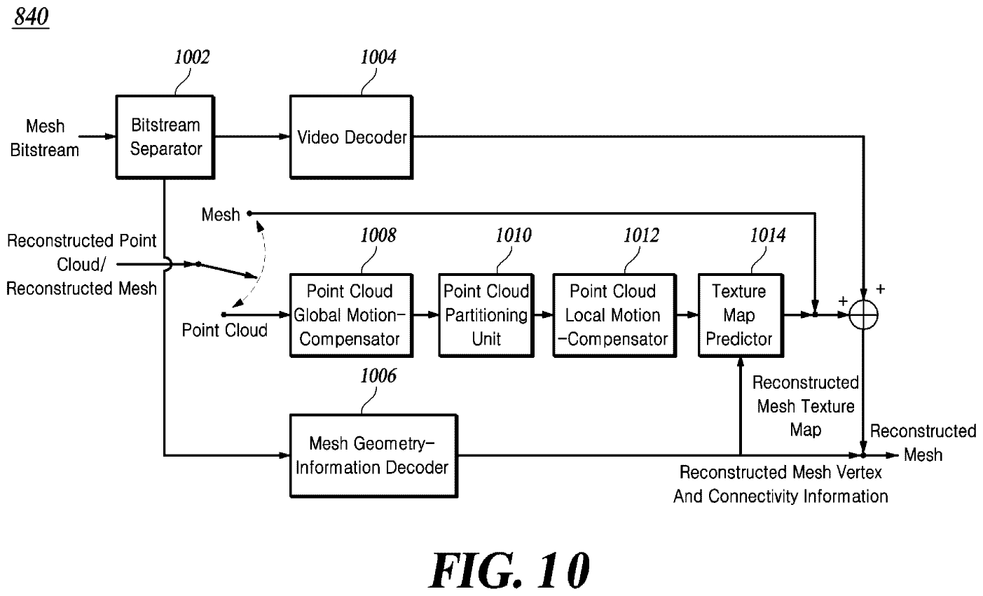

FIG. 10 is a detailed block diagram of a mesh decoder, according to at least one embodiment of the present disclosure.

The mesh decoder 840 receives the mesh bitstream, the reconstructed point cloud, and the reconstructed mesh as input to reconstruct the mesh of the current frame. The mesh decoder 840 may include all or part of a bitstream separator 1002, a video decoder 1004, a mesh geometry-information decoder 1006, a point cloud global motion-compensator 1008, a point cloud partitioning unit 1010, a point cloud local motion-compensator 1012, and a texture map predictor 1014.

The bitstream separator 1002 receives the mesh bitstream as input and separates the mesh bitstream into a texture map bitstream and a mesh geometry information bitstream. The texture map bitstream may be transferred to the video decoder 1004. The mesh geometry information bitstream may be transferred to the mesh geometry-information decoder 1006.

The video decoder 1004 may decode the inputted texture map bitstream to reconstruct a residual texture map. The residual texture map may be summed with the predicted texture map and may be outputted along with the reconstructed mesh vertex and connectivity information.

The mesh geometry-information decoder 1006 decodes the inputted mesh geometry information bitstream to reconstruct mesh vertex and connectivity information. The reconstructed mesh vertex and connectivity information may be transferred to the texture map predictor 1014. Further, the reconstructed mesh vertex and connectivity information may be outputted in the form of a reconstructed mesh along with the reconstructed mesh texture map.

The point cloud global motion-compensator 1008 receives the reconstructed point cloud as input and performs global motion compensation on the geometry information of the reconstructed point cloud. The motion compensation may be performed by using a parameter representing the global motion between the original mesh vertices and the reconstructed point cloud. In this case, the global motion compensation uses the same parameters for all points to perform the motion compensation. The global motion parameters may be obtained from the geometry information entropy-decoder 904. The global motion-compensated reconstructed point cloud may be transferred to the point cloud partitioning unit 1010.

The point cloud partitioning unit 1010 receives and partitions the global motion-compensated reconstructed point cloud into smaller units. In this case, a tree structure-based partitioning method such as a binary tree, quadtree, octree, K-D tree, or the like may be used as the partitioning method. The partitioned point cloud may be transferred to the point local motion-compensator 1012.

The point cloud local motion-compensator 1012 performs local motion compensation on the geometry information of the inputted partitioned point cloud by using parameters related to local motion compensation. Here, the parameters may be motion vectors represented as three-dimensional vectors. Further, the parameters may be obtained from the geometry information entropy-decoder 904. The motion-compensated point cloud may be transferred to the texture map predictor 1014.

The texture map predictor 1014 generates a predicted texture map by using the motion-compensated point cloud, reconstructed mesh vertices, and connectivity information. The texture map may be reconstructed by summing the predicted texture map and the differential texture map. Additionally, if a reconstructed point cloud is not inputted to the mesh decoder 840 and a reconstructed mesh of a previous frame is inputted, the differential texture map may be summed with the texture map of the reconstructed mesh of the previous frame to generate a reconstructed mesh texture map. The reconstructed mesh texture map may be outputted in the form of a reconstructed mesh along with reconstructed mesh vertex and connectivity information.

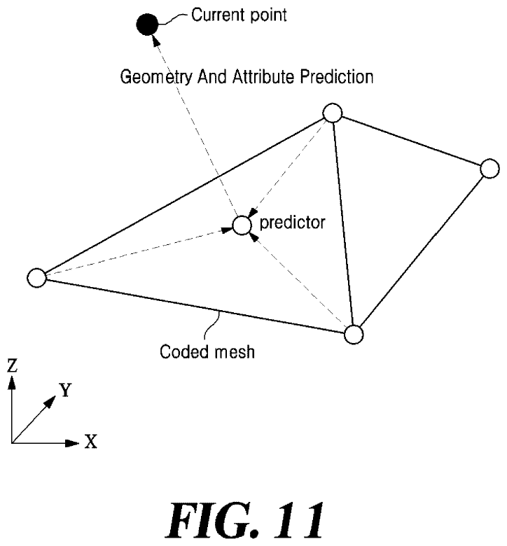

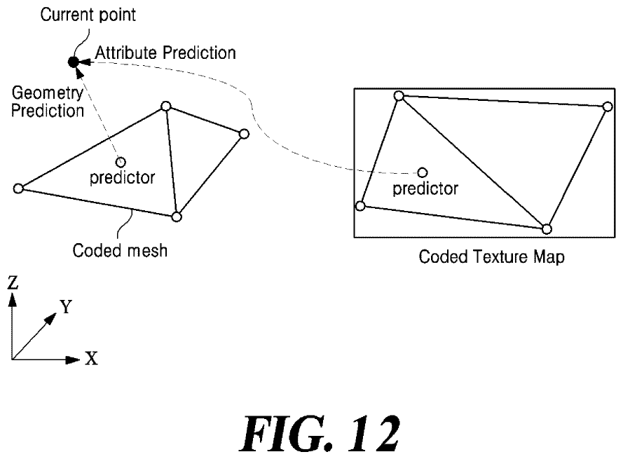

Referring now to FIGS. 11 and 12, the following describes a method of utilizing a reconstructed mesh when a current point is predicted by the geometry information prediction-encoder 604 and the attribute information prediction-encoder 626 of the point cloud encoder 530, and the geometry information prediction-decoder 918 and the attribute information prediction-decoder 926 of the point cloud decoder 820.

FIG. 11 is a diagram illustrating a method of predicting geometry information and attribute information of a point cloud by using a reconstructed mesh.

As illustrated in FIG. 11, for the reconstructed mesh, each vertex may include geometry information and attribute information, and one surface of the triangular mesh may include a total of three vertices.

For predicting the current point, a face of the mesh having a face closest to the current point may be selected, and information of the vertices included in the face may be utilized. At this time, the encoding device may find the face closest to the current point based on a distance. The decoding device may select a particular mesh face by receiving information such as an index of a face of the reconstructed mesh and a three-dimensional motion vector from the encoding device.

Then, a representative point may be generated from the selected face, and the representative point may be used as a predicted point. At this time, the geometry information and attribute information of the representative point may be calculated from the geometry information of the three vertices included in the mesh face. For example, the geometry information and attribute information of the representative point may be a weighted sum of the geometry information and attribute information of three vertices included in the selected mesh face. In this case, a fixed value may be used as the weight according to an agreement between the encoding device and the decoding device. Alternatively, the geometry information of the representative point may be the position of the center of gravity of the three vertices.

FIG. 12 is a diagram illustrating a method of predicting geometry information and attribute information of a point cloud by using a reconstructed mesh having a texture map.

As illustrated in FIG. 12, for the reconstructed mesh, each vertex may include geometry information and may include attribute information in the form of a texture map.

For predicting the current point, a face of the mesh having a face closest to the current point may be selected, and the attribute information of the texture map may be used based on the information on the vertices included in the face and the coordinates of the texture map included in the vertices. At this time, the encoding device may find the face closest to the current point based on the distance. The decoding device may select a particular mesh face by receiving, from the encoding device, information such as an index of a face of the reconstructed mesh and a three-dimensional motion vector.

A representative point may then be generated from the selected faces, and the representative point may be used as a predicted point. In this case, the geometry information of the representative point may be calculated from the geometry information of three vertices included in the mesh face. For example, the geometry information of the representative point may be a weighted sum of the geometry information of three vertices included in the selected mesh face. In this case, the weight may be a fixed value based on an agreement between the encoding device and the decoding device. Alternatively, the geometry information of the representative point may be the position of the center of gravity of the three vertices.

Then, the coordinates of the texture map at the relevant position may be generated based on the coordinates of the vertices, the coordinates of the texture map of the vertices, and the geometry information of the representative point. By using the coordinates of the texture map of the representative point, attribute information of the texture map at the relevant position may be determined as attribute information of the representative point.

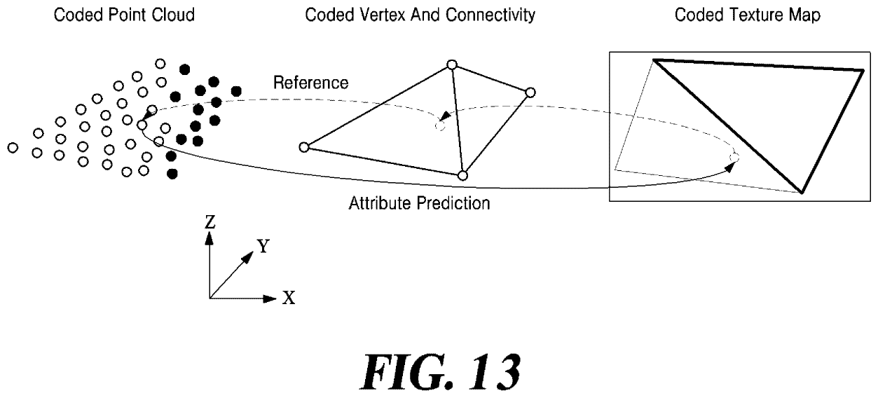

Referring now to FIG. 13, the following describes a method performed by the texture map predictor 708 of the mesh encoder 550 and the texture map predictor 1014 of the mesh decoder 840 for generating a predicted texture map based on the motion-compensated point cloud and the geometry information of the reconstructed current mesh.

FIG. 13 is a diagram illustrating a method of predicting a mesh texture map by using a reconstructed point cloud of a previous frame.

The geometry information of the reconstructed mesh of the current frame may include three-dimensional coordinates of the vertices, connectivity of the vertices, and two-dimensional coordinates of the texture map.

As shown in the example of FIG. 13, a face of the mesh may be obtained based on the three-dimensional coordinates and connectivity information of the vertices, and the attribute information of the reconstructed point cloud may be projected onto the face. Further, the projected attribute information may be projected again to the texture map based on the texture map coordinates of the vertices. The predicted texture map may be the image resulting from projecting the attribute information of the point cloud to the UV domain based on the coordinates of the vertices and the coordinates of the texture map.

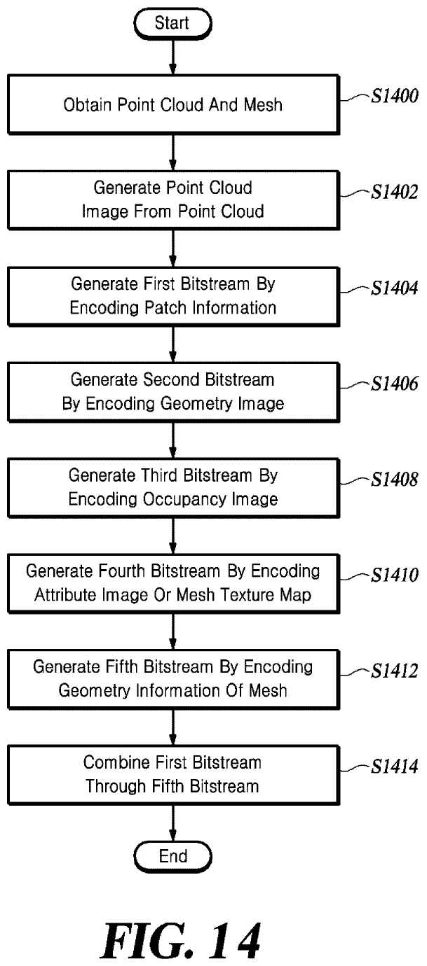

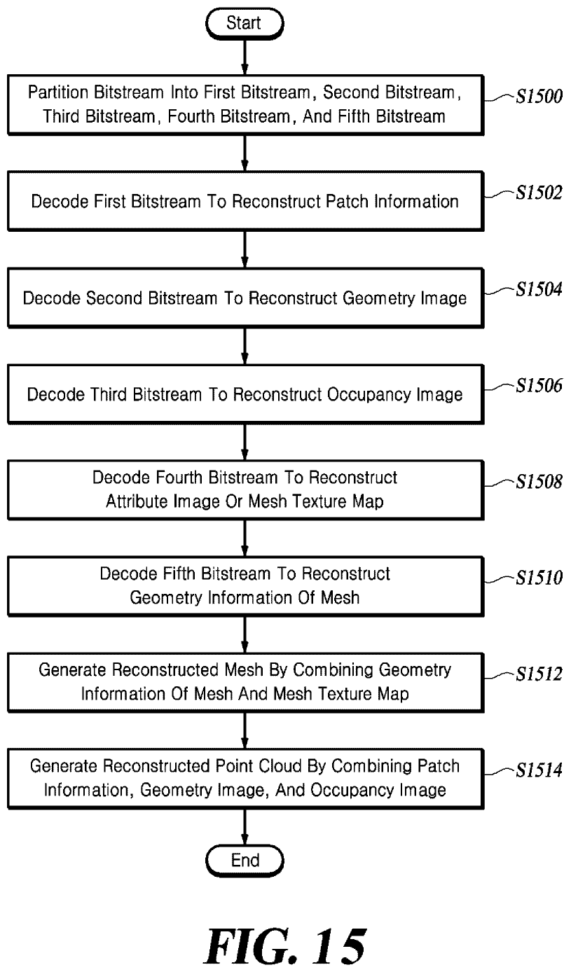

Hereinafter, a method of encoding a point cloud and a mesh and a method of decoding a point cloud and a mesh are described by using the illustrations of FIGS. 14 and 15.

FIG. 14 is a flowchart of a method of encoding a point cloud and a mesh, according to at least one embodiment of the present disclosure.

An encoding device obtains a point cloud and a mesh (S1400).

The encoding device generates a point cloud image from the point cloud (S1402). Here, the point cloud image includes patch information, a geometric image, an occupancy image, and an attribute image.

The patch information is the information used when a plurality of patches categorized in a three-dimensional space are mapped onto a two-dimensional projective plane. Thus, the patch information may include a coordinate value in the three-dimensional space of each patch and information in the three-dimensional space such as width, length, depth, and the like. The patch information may also include coordinate values in a two-dimensional projective plane and information such as horizontal and vertical lengths, and the like.

The geometric image is an image obtained by two-dimensionally mapping the distances between points' locations in the three-dimensional space and the projective plane by using the patch information. In other words, the geometric image may be a map of the depth between the points and the two-dimensional plane when the three-dimensional space is projected onto the two-dimensional plane.

The occupancy image is an image indicative of the positions where the multiple patches classified in the three-dimensional space are projected as an image on the two-dimensional projective plane. In other words, an occupancy image may be a binary map with a 0 or 1 representation of whether a point is projected or not for each pixel position.

The attribute image may be generated from the attribute information of the point cloud. The attribute image is a two-dimensional image generated by projecting the attribute values of the points in the three-dimensional space onto a projective plane.

The encoding device encodes the patch information to generate a first bitstream (S1404).

The encoding device encodes the geometric image to generate a second bitstream (S1406).

The encoding device encodes the occupancy image to generate a third bitstream (S1408).

The encoding device encodes the attribute image or mesh texture map to generate a fourth bitstream (S1410).

The encoding device determines, on a frame-by-frame basis, information indicating whether the image to be encoded is an attribute image of a point cloud or a mesh texture map.

The encoding device may encode the attribute image by performing inter prediction with reference to the mesh texture map, as shown in the example of FIG. 2. Alternatively, the encoding device may encode the mesh texture map by performing the inter prediction by referring to the attribute image of the point cloud, as in the example of FIG. 3.

The encoding device may utilize a video encoding technology, such as H.264/AVC, H.265/HEVC, H.266/VVC, VP8, VP9, AV1, or the like, to generate the second bitstream to the fourth bitstream.

The encoding device encodes the geometry information of the mesh to generate a fifth bitstream (S1412). Here, the geometry information of the mesh includes mesh vertices, mesh connectivity, and texture map vertices of the mesh.

The encoding device combines the first bitstream through the fifth bitstream (S1414).

The encoding device may include a symbol representing a type of each bitstream at the beginning of each bitstream and may combine each bitstream according to the symbol and a preset order.

FIG. 15 is a flowchart of a method of decoding a point cloud and a mesh, according to at least one embodiment of the present disclosure.

The decoding device separates the bitstream into a first bitstream, a second bitstream, a third bitstream, a fourth bitstream, and a fifth bitstream (S1500).

The decoding device may decode a symbol representing a type of each bitstream, which is included at the beginning of each bitstream, and may separate each bitstream according to the decoded symbol.

The decoding device decodes the first bitstream to reconstruct the patch information (S1502).

The decoding device decodes the second bitstream to reconstruct the geometric image (S1504).

The decoding device decodes the third bitstream to reconstruct the occupancy image (S1506).

The decoding device decodes the fourth bitstream to reconstruct the attribute image or mesh texture map (S1508).

The decoding device may decode information indicating whether the image to be reconstructed is an attribute image of a point cloud or a mesh texture map, and decode the fourth bitstream according to the decoded information.

The decoding device may decode the attribute image by performing an inter prediction with reference to the mesh texture map, as shown in the example of FIG. 2. Alternatively, the decoding device may decode the mesh texture map by performing inter prediction by referring to the attribute image of the point cloud, as in the example of FIG. 3.

To decode the second bitstream to the fourth bitstream, the decoding device may utilize a video decoding technology, such as H.264/AVC, H.265/HEVC, H.266/VVC, VP8, VP9, AV1, or the like.

The decoding device decodes the fifth bitstream to reconstruct the geometry information of the mesh (S1510). Here, the geometry information of the mesh includes mesh vertices, mesh connectivity, and texture map vertices of the mesh.

The decoding device combines the geometry information of the mesh and the mesh texture map to generate a reconstructed mesh (S1512).

The decoding device combines the patch information, the geometric image, the occupancy image, and the attribute image to generate a reconstructed point cloud (S1508).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

1. A method performed by a point cloud-and-mesh decoding device for decoding a point cloud and a mesh, the method comprising:
separating a bitstream into a first bitstream, a second bitstream, a third bitstream, a fourth bitstream, and a fifth bitstream;
reconstructing patch information by decoding the first bitstream;
reconstructing a geometric image by decoding the second bitstream;
reconstructing an occupancy image by decoding the third bitstream;
reconstructing an attribute image or a mesh texture map by decoding the fourth bitstream; and
reconstructing geometry information of the mesh by decoding the fifth bitstream;
wherein the geometry information of the mesh contains vertices of the mesh, connectivity of the mesh, and vertices of the mesh texture map.

2. The method of claim 1, further comprising:
generating a reconstructed mesh by combining the geometry information of the mesh with the mesh texture map.

3. The method of claim 1, further comprising:
generating a reconstructed point cloud by combining the patch information, the geometric image, the occupancy image, and the attribute image.

4. The method of claim 1, wherein separating the bitstream comprises:
decoding a symbol that represents a type of each bitstream and included in a leading portion of each bitstream, and separating each bitstream according to the symbol.

5. The method of claim 1, wherein reconstructing the geometric image, reconstructing the occupancy image, and reconstructing the attribute image or the mesh texture map comprises utilizing a video decoding technology.

6. The method of claim 1, wherein reconstructing the attribute image or the mesh texture map comprises:
decoding indicative information indicating whether an image to be reconstructed is the attribute image in the point cloud or the mesh texture map, and decoding the fourth bitstream according to the indicative information.

7. The method of claim 1, wherein the patch information is used when a plurality of patches classified in a three-dimensional space is mapped onto a projective plane that is two-dimensional.

8. The method of claim 7, wherein the geometric image comprises an image obtained by two-dimensionally mapping distances between point locations in the three-dimensional space and the projective plane by using the patch information.

9. The method of claim 7, wherein the occupancy image comprises an image indicative of locations where the plurality of patches are projected as an image on the projective plane that is two-dimensional.

10. The method of claim 7, wherein the attribute image comprises a two-dimensional image generated by projecting attribute values of points in the three-dimensional space onto the projective plane.

11. The method of claim 1, wherein reconstructing the attribute image or the mesh texture map comprises:
performing an inter prediction with reference to the mesh texture map to reconstruct the attribute image.

12. The method of claim 1, wherein reconstructing the attribute image or the mesh texture map comprises:
performing an inter prediction with reference to the attribute image of the point cloud to reconstruct the mesh texture map.

13. A method performed by a point cloud-and-mesh encoding device for encoding a point cloud and a mesh, the method comprising:
obtaining the point cloud and the mesh;
generating a point cloud image from the point cloud, wherein the point cloud image includes patch information, a geometric image, an occupancy image, and an attribute image;
encoding the patch information;
encoding the geometric image;
encoding the occupancy image;
encoding the attribute image or a mesh texture map; and
encoding geometry information of the mesh;
wherein the geometry information of the mesh contains vertices of the mesh, connectivity of the mesh, and vertices of the mesh texture map.

14. The method of claim 13, further comprising:
combining a first bitstream generated by encoding the patch information, a second bitstream generated by encoding the geometric image, a third bitstream generated by encoding the occupancy image, a fourth bitstream generated by encoding the attribute image or the mesh texture map, and a fifth bitstream generated by encoding the geometry information of the mesh.

15. The method of claim 14, wherein the combining comprises:
including in a leading portion of each bitstream a symbol representing a type of each bitstream, and combining bitstreams according to the symbol and in a predetermined order.

16. The method of claim 11, wherein encoding the geometric image, encoding the occupancy image, and encoding the attribute image or the mesh texture map comprises utilizing a video encoding technology.

17. The method of claim 11, wherein encoding the attribute image or the mesh texture map comprises:
determining, on a frame-by-frame basis, information indicating whether an image to be encoded is the attribute image in the point cloud or the mesh texture map.

18. A computer-readable recording medium storing a bitstream generated by a point cloud-and-mesh encoding method, the point cloud-and-mesh encoding method comprising:
obtaining a point cloud and a mesh;
generating a point cloud image from the point cloud, wherein the point cloud image includes patch information, a geometric image, an occupancy image, and an attribute image;
encoding the patch information;
encoding the geometric image;
encoding the occupancy image;
encoding the attribute image or a mesh texture map; and
encoding geometry information of the mesh;
wherein the geometry information of the mesh contains vertices of the mesh, connectivity of the mesh, and vertices of the mesh texture map.
